(19) United States
(12) Patent Application Publication
(10) Pub. No.: US 2015/0357967 A1
(43) Pub. Date: Dec. 10, 2015

(54) APPARATUS AND METHOD OF MOUNTING AND SUPPORTING A SOLAR PANEL

(71) Applicant: FlexFlange, LLC, Austin, TX (US)

(72) Inventors: Michael Brennan, Austin, TX (US); Charles F. Gay, Westlake Village, CA (US)

(73) Assignee: FLEXFLANGE, LLC, Austin, TX (US)

(21) Appl. No.: 14/551,614

(22) Filed: Nov. 24, 2014

Related U.S. Application Data
(60) Provisional application No. 62/007,468, filed on Jun. 4, 2014.

(51) Int. Cl. H02S 30/10; H01L 31/042

(52) U.S. Cl. CPC H02S 30/10; H02S 20/00

(57) ABSTRACT

Mounting and supporting a solar panel. At least some of the illustrative embodiments are apparatuses including: a solar module comprising a cover layer; a solar array defining a first and a second side, the first side of the solar array coupled to the cover layer; a back cover that defines an inside surface and an outside surface opposite the inside surface, the inside surface coupled to the second side of the solar array; the cover layer, solar array and back cover together define an outer perimeter and a back cover plane; a first mounting flange coupled to the outside surface of the back cover, the first mounting flange extends outward beyond the outer perimeter; and a second mounting flange coupled to the outside surface of the back cover, the second mounting flange extends outward beyond the perimeter in a direction opposite the first mounting flange.

### CROSS-REFERENCE TO RELATED APPLICATIONS

This application claims priority to U.S. Provisional Application No. 62/007,468, filed Jun. 4, 2014, titled “Apparatus and Method of Mounting and Supporting a Flexible Solar Panel,” the disclosure of which is incorporated herein by reference as if reproduced in full below.

### BACKGROUND

The photovoltaic (PV) module manufacturing industry has evolved over the past 40 years. Recent interest and growth in the industry has dramatically changed the way solar modules are made, constantly pushing for higher output and lower cost. The emphasis has primarily been in PV technology (amorphous and crystalline). Little effort has gone into the materials and design of the solar module that is associated with providing the required structural support to pass the International Electrotechnical Commission (IEC) and Underwriters Laboratories (UL) mechanical load tests.

In the past, solar panels used frames and/or tempered/heat treated glass for structural strength. The solar panels may have been mounted using a clamp mechanism or other customized mounting hardware. However, an apparatus and method for mounting solar modules in a way which reduces the need for customized hardware and clamps, while maintaining and/or improving structural strength and reducing costs, provides many benefits.

### BRIEF DESCRIPTION OF THE DRAWINGS

For a detailed description of various embodiments, reference will now be made to the accompanying drawings, not to scale, in which:

FIG. 1 shows a perspective view of a solar module in accordance with at least some embodiments;

FIG. 2 shows a elevation view of a solar module mounted by clamps;

FIG. 3A shows an overhead view of a solar module coupled to a plurality of mounting tabs in accordance with at least some embodiments;

FIG. 3B shows an elevation view of a solar module coupled to a mounting tab in accordance with at least some embodiments;

FIG. 4A shows an overhead view of an example mounting tab in accordance with at least some embodiments;

FIG. 4B shows an overhead view of an example mounting tab in accordance with at least some embodiments;

FIG. 4C shows an overhead view of an example mounting tab in accordance with at least some embodiments;

FIG. 5 shows an elevation view of a mounted solar module in accordance with at least some embodiments;

FIG. 6A shows a back elevation view of a solar module coupled to a plurality of mounting straps in accordance with at least some embodiments;

FIG. 6B shows an elevation view of a solar module coupled to a mounting strap in accordance with at least some embodiments;

FIG. 6C shows an elevation view of a solar module adhesively coupled to a mounting strap in accordance with at least some embodiments;

FIG. 7 shows an elevation view of a mounted solar module in accordance with at least some embodiments;

FIG. 8A shows a perspective view of a mounting rail in accordance with at least some embodiments;

FIG. 8B shows a perspective view of a mounting rail in accordance with at least some embodiments;

FIG. 9 shows a back elevation view of a solar module coupled to a plurality of mounting rails in accordance with at least some embodiments;

FIG. 10 shows an elevation view of a solar module coupled to a plurality of mounting rails in accordance with at least some embodiments;

FIG. 11 shows an elevation view of a solar module coupled to a mounting rail in accordance with at least some embodiments;

FIG. 12A shows a back elevation view of a solar module coupled to a mounting sheet in accordance with at least some embodiments;

FIG. 12B shows an elevation view of a solar module coupled to a mounting sheet in accordance with at least some embodiments;

FIG. 13 shows a mounting system in accordance with at least some embodiments; and

FIG. 14 shows a graph of spacing considerations in accordance with at least some embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection or through an indirect connection via other devices and connections.

“Quadrilateral” shall mean a four-sided mathematical shape without self-intersecting sides (i.e., a simple quadrilateral).

“Annealed glass” shall mean glass that has been subjected to an annealing process. Annealed glass shall not include “tempered glass” or “heat treated glass” even if the tempered glass or heat treated glass is made from annealed glass. In other words, upon becoming heat treated or tempered, glass loses its “annealed” status.

“Heat treated glass” shall mean glass that has a surface compression of between 3,500 to 7,500 pounds per square inch (“PSI”) inclusive.

“Tempered glass” shall mean glass that has a surface compression of at least 10,000 PSI or an edge compression of at least 8,700 PSI.

“About,” in reference to a numeric quantity, shall mean the recited value plus or minus ten percent (10%) of the recited value.

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment. Various embodiments are directed to aspects of mounting a solar module. The specification turns first to a high level overview of a solar module.

The example embodiments are directed to a solar panel and a related mounting method that utilizes mounting hardware that couples to the back or underside of the solar panel. More particularly, the example embodiments use one or more mounting flanges on each side of a solar panel, where the mounting flanges couple to the outside surface of the back cover of a solar panel. The mounting flanges extend beyond a perimeter of the solar array, and are the mechanism by which the solar module (the solar panel and mounting hardware) couple to underlying support structure. Using mounting flanges in this way not only reduces cost and installation time, but also enable placement of a connector assembly on the perimeter of the solar panel, reducing electrical wiring time associated with solar module installation. The specification first turns to an example solar array and associated electrical connector assembly in accordance with example systems.

Solar Array Overview

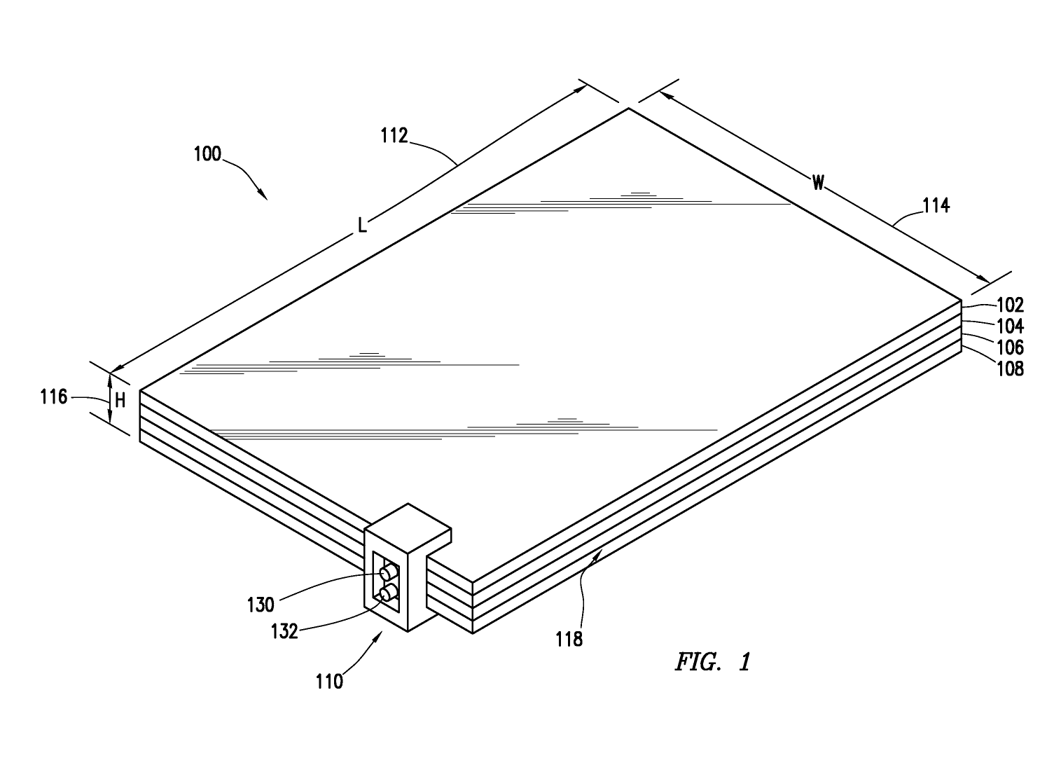

FIG. 1 shows a perspective view of a solar panel 100 having an electrical edge connector assembly 110 (hereafter just “connector assembly 110”) in accordance with at least some embodiments. Any number of connector assemblies may be contemplated (e.g. one, two, etc.). In particular, the solar panel 100 may be one of a set of solar photovoltaic modules (the set being “a set of solar modules”). The example solar panel 100 is a three-dimensional quadrilateral having a top cover layer 102 disposed on top of an encapsulate layer 104. Encapsulate layer 104 is disposed on top of a solar array layer 106, and solar array layer 106 is disposed on top of a back cover 108. Within the solar panel 100, layers 102, 104, 106, and 108 lie parallel to one another. It is noted that the relative thickness of each layer, the size of the solar module, and the size of the electrical connector as shown in FIG. 1 are not to scale. The sides of the solar panel 100 are defined by an outer perimeter 118, where the outer perimeter resides between the plane defined by an outside surface of cover layer 102 and the plane defined by the outside surface of the back cover 108.

In example cases, the length 112 ‘L’ of the solar panel 100 may be between and including 1 meters (m) and about 2.6 m in length; the width 114 ‘W’ may be between and including 0.6 m and 1.1 m; and the height 116 ‘H’ may be about five to eight millimeters (mm). For ease of discussion, the example solar panel 100 comprises two “long” sides parallel and opposite to one another measuring ‘L’, and two “short” sides parallel and opposite to one another measuring ‘W.’ Furthermore, the short sides are perpendicular to the long sides. In addition, although the discussion provides approximate dimensions, the dimensions of the solar panel 100 are not limited to the previously discussed dimensions and the solar panel 100 may be of any suitable size and shape. Each of the layers will now be discussed in turn.

In example systems, cover layer 102 is a thin layer of glass (e.g., annealed glass, heat-treated glass, or tempered glass). The cover layer 102 may be approximately 3.2 mm thick, but may be as thin as 2.0 mm or as thick as 5.0 mm. In other example systems, cover layer 102 may be a non-glass material, such as a thin-film plastic. The cover layer 102 is the initial layer of the solar panel 100 upon which photons from the sun are incident, and thus, the composition of the cover layer 102 may be any material with sufficient transmittance to enable photons to pass through the cover layer 102 and onto the solar array layer 106. In other words, if a material other than glass is used, the material may have a transmittance equal to or greater than that of glass.

Disposed beneath and adhered to the bottom of cover layer 102 is an encapsulate layer 104. The encapsulate layer 104 may be a thin-film plastic melted to the interior surface of cover layer 102 during construction of the solar panel 100. For example, the layers of the solar panel 100 may be passed through heater rollers melting the encapsulate plastic layer and adhering the encapsulate to the cover layer 102, the solar array layer 106, and the back layer 108. The encapsulate layer 104 reduces water intrusion.

Disposed beneath the encapsulate layer 104 is a solar cell or solar array layer 106. In one embodiment, the solar array layer 106 is an array of photovoltaic wafers. In another embodiment, the solar array layer 106 may be a continuous layer of amorphous silicon. The solar array layer 106 is electrically coupled to the connector assembly 110.

Disposed beneath the solar array layer 106 is a back cover 108. The back cover 108 may be glass (e.g., annealed glass, heat-treated glass, or tempered glass). In yet still other embodiments, the back cover 108 may be a thin-layer of composite plastic or laminate.

The connector assembly 110 is mechanically coupled to a portion of the outer perimeter 118 of the solar panel 100. As shown, a portion of the connector assembly 110 also couples to the outer surface of the cover layer 102, and another portion of the connector assembly 110 couples to the outer surface of the back cover 108. The connector assembly 110 defines electrical pins 130 and 132 electrically coupled to the photovoltaic elements of the solar array layer 106. In one example system, the connector assembly 110 may be created by way of reaction injection molding (RIM). Because the various mounting mechanisms (discussed in detail below) leave the perimeter 118 of the solar panel uncovered, the connector assembly may be mounted on any portion of the outer perimeter 118, unlike related-art solar panels where the connector assembly is mounted on the outer surface of the back cover 108. The specification now turns to issues with related-art mounting systems.

Issues in the Related-Art

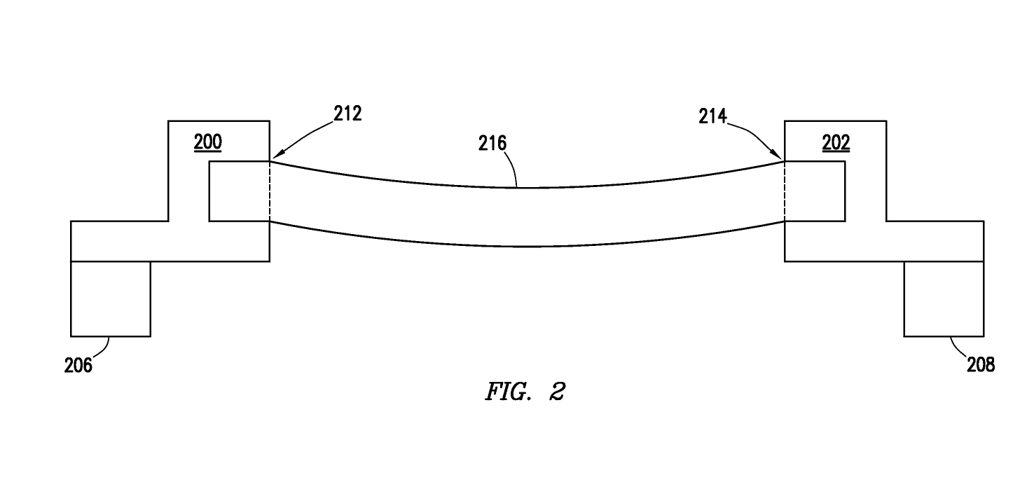

FIG. 2 shows a cross-sectional elevation view of a solar panel 216 mounted in accordance with related-art procedures. In particular, in the related-art, solar panel 216 is mounted by way of c-clamps (e.g., c-clamps 200 and 202 visible in FIG. 2) that span the perimeter of the solar module. The c-clamps 200 and 202, in turn, are coupled to respective mounting rails 206 and 208, such as by way of screws or bolts (not specifically shown). The mounting rails 206 and 208 are coupled to a separate structure (such as a roof of a home). Thus, the configuration of the mounting systems in the related-art is bulky, expensive, and in some cases requires custom mounting hardware.

Furthermore, the clamps are rigid constraints on the ability of the solar module to bend and flex. Whether being tested for structural rigidity (e.g., under IEC or UL mechanical load testing regimes), or experiencing wind loads in actual use, the integrity of the example c-clamp 200 and 202 results in significant bending moments and stresses in the solar module at the intersection of the c-clamps and the solar panel 216 (location of the stresses shown at dotted lines 212 and 214). In particular, as the solar panel 216 deflects under load (it is noted that the deflection shown in FIG. 2 is exaggerated for clarity), the solar panel 216 may experience high stress due to the inability of the solar module to deflect within the c-clamps 200 and 202.

In order to address the high stresses caused by the rigid mounting systems, related-art solar module manufactures are required to design their solar modules with more structural rigidity. In most cases, the structural rigidity is implemented by increasing the thickness of the glass cover layer and/or the thickness of the glass back cover, which increases cost and weight. In addition to, or in place of, thicker glass, manufacturers may also use stronger glass (e.g., heat treated or tempered glass), which also increases the cost of the solar module.

The inventors of the present specification have found that issues with the related-art can be addressed, at least in part, by way of flexible mounting structures coupled to the solar module. Four types of flexible mounting structures are contemplated and will be discussed in turn: tabs; straps; rails; and sheets.

Mounting Tabs

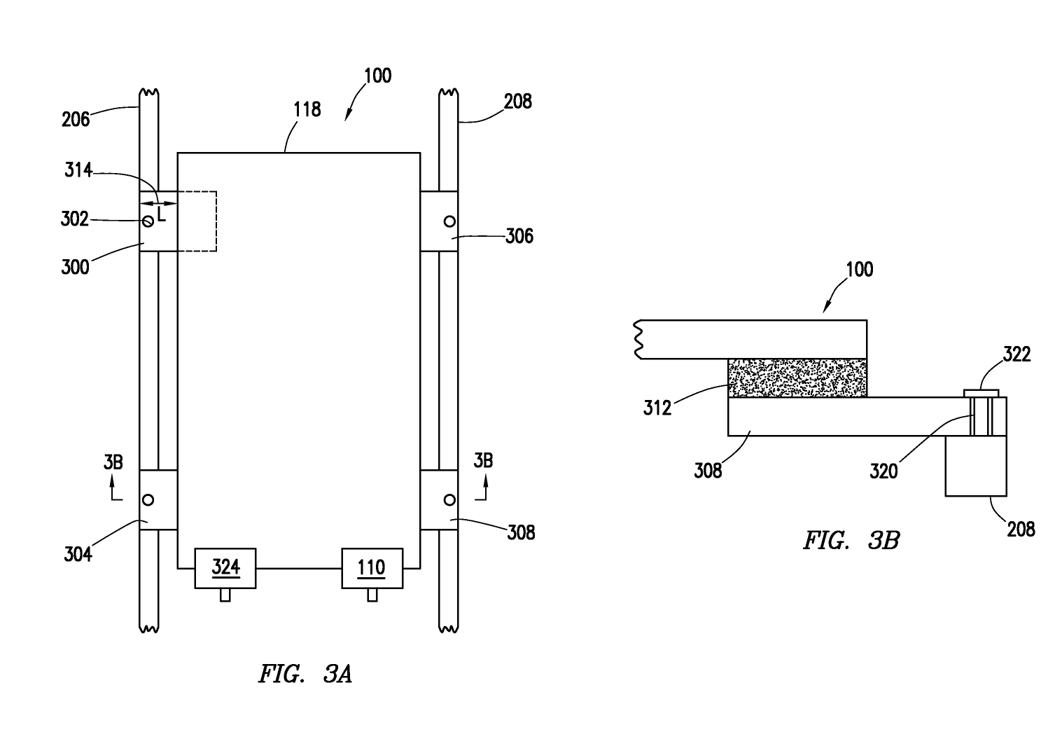

FIG. 3A shows an overhead view of solar panel 100 in accordance with at least some embodiments. In particular, solar panel 100 is coupled to mounting rails 206 and 208 by way of a plurality of mounting tabs 300, 304, 306, and 308 coupled to the back cover 108 (not visible in FIG. 3A). Additionally, connector assembly 110 is shown coupled to the outer perimeter 118 of solar panel 100. Although FIG. 1 showed one connector assembly 110, as shown in FIG. 3A, more than one connector assembly is possible. For example, FIG. 3A shows connector assembly 110 and connector assembly 324 coupled to the same side of the outer perimeter 118 of solar panel 110.

So as not to unduly complicate the discussion, example mounting tab 300 will be discussed as representative of all the example mounting tabs.

In example systems, the proximal portion of mounting tab 300 is coupled to the bottom of solar panel 100 (i.e., coupled to the outer surface of back cover 108, the proximal portion shown by dotted lines in FIG. 3A). The distal portion of mounting tab 300 (i.e., the portion of mounting tab 300 which is visible in FIG. 3A) extends beyond the outer perimeter 118 of solar panel 100 by length 314 ‘L’, where L may be approximately 25 mm. The distal portion of mounting tab may also be considered a “mounting flange.” In the example system shown, the distal portion of mounting tab 300 has an aperture 302 through which mounting hardware may be disposed to enable coupling of the solar panel 100 to the mounting rail 206. Other mounting mechanisms (discussed more below) do not require the aperture and mounting hardware.

In the example system, another mounting tab 304 may be coupled along the same side of the solar panel 100, but spaced some distance apart (spacing discussed in more detail below) in order to enable a strong mounting to mounting rail 206. Further in the example system, a third mounting tab 306 may be coupled opposite the first mounting tab 300, where the mounting tab 306 is coupled on the opposite side of the solar panel 100. And lastly, a fourth mounting tab 308 may be coupled opposite the second mounting tab 304, on the same side of the solar panel 100 as mounting tab 306. Although four example mounting tabs are shown in FIG. 3A, any number of mounting tabs may be contemplated to enable mounting the solar panel 100. Moreover, mounting tabs need not be used in matched sets. For example, for an appropriately sized solar panel 100, two mounting tabs may be installed on one side, and only a single mounting tab used on the opposite side. The combination of the solar panel 100 and the mounting tabs may be considered a “solar module.”

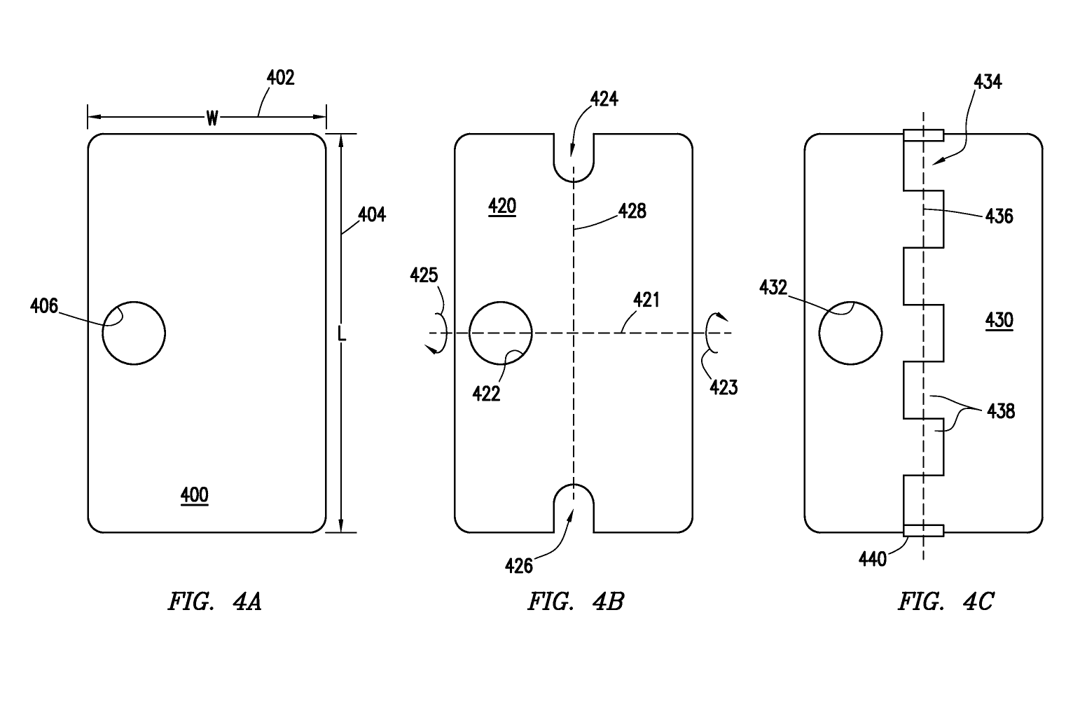

FIGS. 4A, 4B, and 4C provide a more detailed discussion of the mounting tabs, but for now the specification now turns to a discussion regarding the adhesive connection between example mounting tab 300 and the solar panel 100.

Adhesive Connection

FIG. 3B shows a cutaway, partial side elevation view of solar panel 100 (taken substantially long line 3B-3B of FIG. 3A). In particular, FIG. 3B shows mounting tab 308 coupled to the outer surface of the back cover 108) by way of adhesive 312. In one example embodiment, the adhesive may be double-sided tape (e.g., 3M™ VHB™ 850 Polyester Film Tape, where 3M™ and VHB™ are trademarks owned by the 3M Company of St. Paul, Minn.). In another embodiment, the adhesive may be a silicon adhesive for photovoltaic encapsulation (e.g., Dow Corning® Part No. PV800, where the Dow Corning® trademark is owned by the Dow Corning Corporation of Midland, Mich.). Other adhesives may be used. The adhesive layer 312 couples the proximal portion of the example mounting tab 308 to the outer surface of the back cover 108 (FIG. 1). The distal portion of the example mounting tab comprises aperture 320 through which mounting hardware 322 is disposed, thus coupling mounting tab 308 to mounting rail 208. The description with respect to FIG. 3A and mounting tab 308 is equally applicable to all the example mounting tabs. The specification now turns to a discussion of example variations of the mounting tabs.

Example Structures of the Mounting Tabs

FIG. 4A shows a front elevation view of an example mounting tab 400 (which could be any of the previously discussed mounting tabs). Example mounting tab 400 may be constructed of a solid piece of metallic material (e.g., steel, titanium, or aluminum), or alternatively a composite plastic. The width 402 ‘W’ of mounting tab 400 may be approximately 50 mm to 76 mm; the length 404 ‘L’ of the mounting tab 400 may be approximately 50 mm to 76 mm; and the thickness (not visible in FIG. 4A) may be about 0.75 mm to 3.0 mm, depending on the material used. For the example mounting tab 400, the “short” side of the mounting tab 400 would be perpendicular to the outer perimeter 118 of the solar panel 100, and the “long” side of mounting tab 400 would be parallel to the outer perimeter of solar panel 100.

In addition, example mounting tab 400 comprises aperture 406 through which mounting hardware may be disposed to enable coupling between the solar panel 100 and a mounting structure (e.g., mounting rail 206). A second variation of the mounting tab will now be discussed: a notched mounting tab.

FIG. 4B shows a front elevation view of an example mounting tab 420 in accordance with at least some embodiments. As with mounting tab 400, mounting tab 420 may be constructed of a solid piece of metallic material (e.g., steel, titanium, or aluminum), or alternatively a composite plastic. Additionally, mounting tab 420 may have the same or similar dimensions as mounting tab 400, as well as the same or similar coupled orientation in relation to solar panel 100. Likewise, mounting tab 420 may further comprise an aperture 422 through which mounting hardware may be disposed to enable coupling between the solar panel 100 and a mounting structure.

Example mounting tab 420 also defines two notches 424 and 426 disposed opposite one another. In FIG. 4B, notches 424 and 426 are located on the sides of mounting tab 420 that, when coupled to the solar panel, the sides will be perpendicular to the outer perimeter 118. When the example mounting tab 420 is adhered to a solar panel, notches 424 and 426 are located at an intersection between mounting tab 420 and the outer perimeter of the solar panel 100. Furthermore, when mounting tab 420 is adhesively coupled to solar panel 100, each notch 424 and 426 defines a channel perpendicular to the plane defined by the back cover 108 (in the view of FIG. 4B, the plane of the page).

In example systems, the notches 424 and 426 may be, but are not limited to, 3.0 mm in diameter, and the notches may extend in towards the middle of the mounting tab 420 by as much as 12.5 mm or more. Although notches 424 and 426 are shown in FIG. 4B to be roughly semi-circular in shape, the notches may be any contemplated shape (e.g., squared-off edges, triangular).

When mounting tab 420 is adhesively coupled to the solar panel, notches 424 and 426 enable flexible movement of the distal portion of the mounting tab 400 relative to the proximal portion. In particular, the notches enable two different types of movement—a “hinge” type movement, and a flexing movement. For example, the notches enable the mounting tab 420 to “hinge” about an axis of rotation roughly defined by the dashed line 428. Moreover, the notches enable the distal portion to flex oppositely of the proximal portion. For example, in certain situations loading may cause the proximal portion of the mounting tab 420 to flex one direction (rotation about axis 421 in the direction indicated by arrow 423) while the distal portion flexes the opposite direction (rotation about axis 421 in the direction indicated by arrow 425). It is noted, however, that example mounting tab 400 may likewise enable similar movements depending on the thickness and material. A third variation of mounting tab will now be discussed: a hinged mounting tab.

FIG. 4C shows an elevation view of an example mounting tab 430 in accordance with at least some embodiments. As with mounting tabs 400 and 420, mounting tab 430 may be constructed of a solid piece of metallic material (e.g., steel, titanium, or aluminum), or alternatively a composite plastic. Additionally, mounting tab 430 may have the same or similar dimensions as mounting tabs 400 and 420, as well as the same or similar coupled orientation in relation to solar panel 100. Likewise, mounting tab 430 may further comprise an aperture 432 through which mounting hardware may be disposed to enable coupling between the solar panel 100 and a mounting structure.

Example mounting tab 430 defines a hinge 434 along the visible surface of mounting tab 430. In one embodiment, hinge 434 may be a barrel-type hinge having interlocking sections 438 disposed around a pin 440. Although a barrel-type hinge is shown, the type of hinge is not limited solely to a barrel-type hinge, and other types of hinges may be contemplated.

When the example mounting tab 430 is adhered to a solar panel, hinge 434 is disposed at an intersection between mounting tab 430 and the outer perimeter of the solar panel 100. When mounting tab 430 is adhesively coupled to the solar panel, hinge 434 enables a pivotal movement of the distal portion of the mounting tab 430 relative to the proximal portion. For example, the hinge enables the mounting tab 430 to pivot about an axis of rotation roughly defined by the dashed line 436.

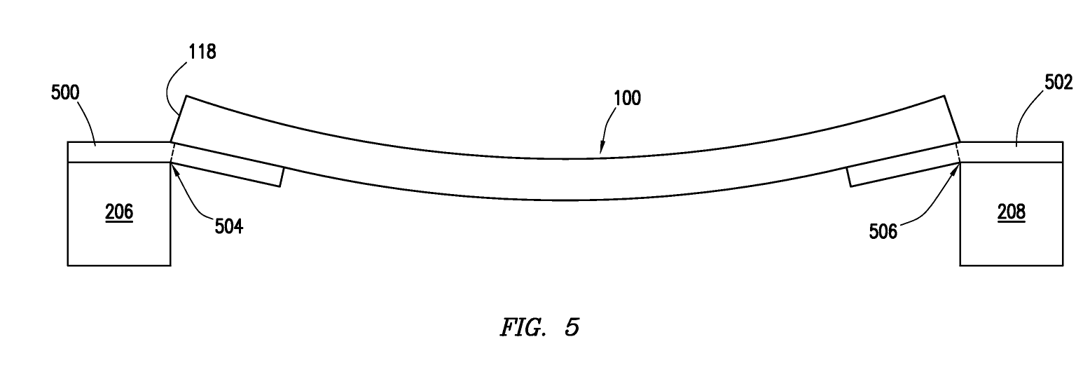

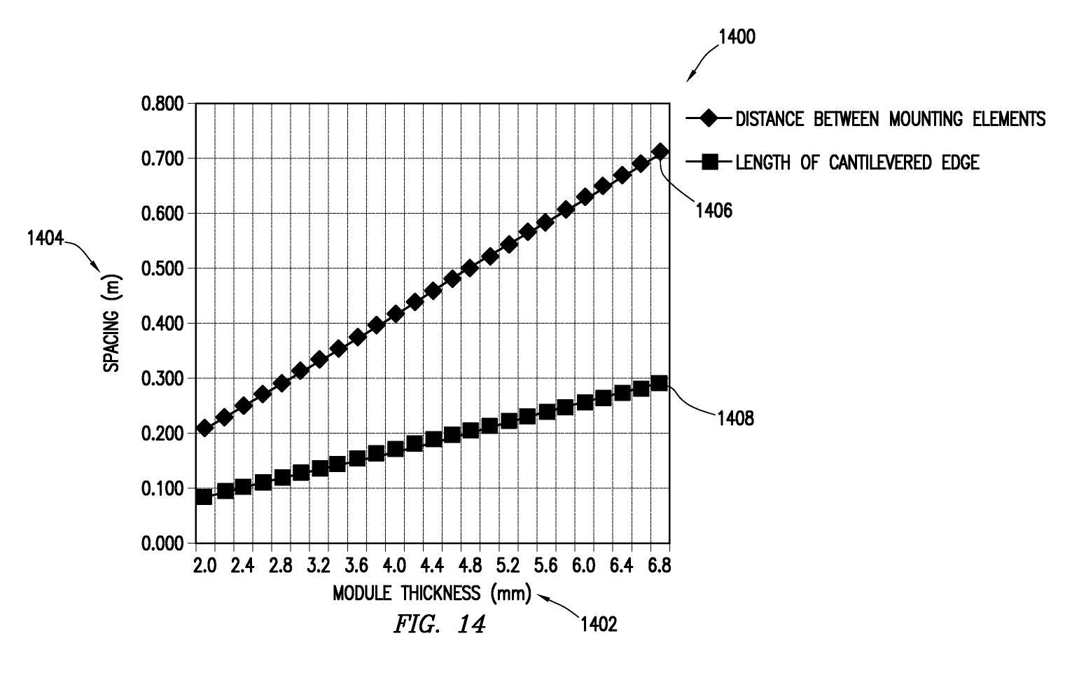

Although all three example mounting tab variations are shown to have an aperture for mounting hardware, in another embodiment, the mounting tabs may be used without such mounting hardware and/or bent into a shape which enables interfacing and coupling with non-bolting mounting systems (discussed in more detail with reference to FIG. 14). Regardless of which example mounting tab 400, 420, or 430 is used, the use of the mounting tabs enables a reduction in stress as the solar module deflects under real or simulated mechanical loading, as discussed in reference to FIG. 5.

Reduced Stress Using Mounting Tabs

FIG. 5 shows a side elevation view of a mounted solar module (i.e. solar panel 100 combined with mounting hardware) in accordance with at least some embodiments, the solar module deflecting under load (with the deflection exaggerated for clarity). In FIG. 5, the proximal portion of mounting tab 500 is coupled to the outer surface of the back cover of the solar panel (i.e., the back cover 108 of FIG. 1). The distal portion of mounting tab 500 extends outwardly from the outer perimeter 118 of the solar panel 100 and couples to the rail 206. Likewise, the proximal portion of mounting tab 502 is coupled to the outer surface of the back cover of the solar panel (i.e., the back cover 108 of FIG. 1). The distal portion of mounting tab 502 extends outwardly from the outer perimeter of the solar panel 100 and couples to the rail 208.

In one embodiment, the dashed lines 504 and 506 indicate the location of the notches 424 and 426 (from FIG. 4B, if present) or location of one end of hinge 436 (from FIG. 4C, if present). At the location of the dashed lines, the mounting tabs bend or flex under the load applied to the solar panel. The bending of flexing of the mounting tabs thus reduces the bending or flexing of the various layers of the solar panel at the interfaces with the mounting tabs. Thus, referring momentarily to FIG. 2, rather than stress points caused by rigidly holding the solar panel during deflection under load, the stress in the solar panel is reduced.

The example mounting tabs may provide sufficient strength to mount smaller solar panels (i.e., a solar panel approximately 0.6 m wide and about 1.1 m long (using four mounting tabs)). In such cases, the reducing in stresses under load may enable construction of a solar panel with thinner glass, and/or with less expensive glass (e.g., annealed glass rather than heat treated or tempered). Larger solar panels may benefit from other mounting means. The specification now turns to a discussion of mounting straps.

Mounting Straps

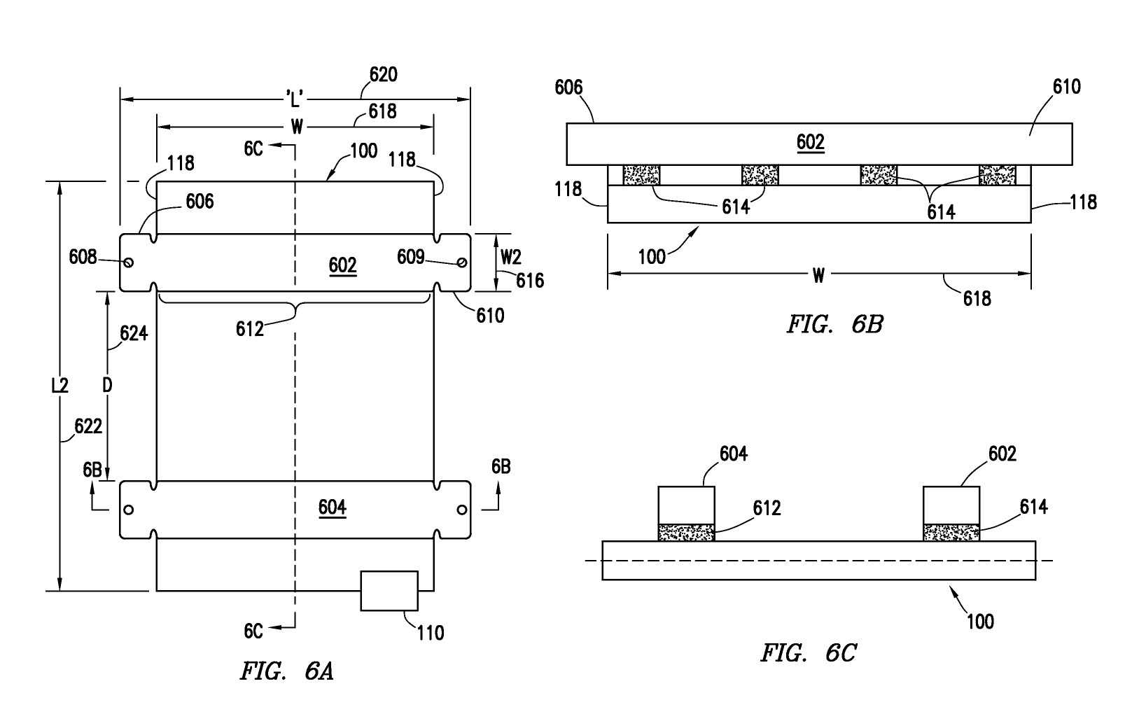

FIG. 6A shows a back elevation view of a solar panel having a plurality of mounting straps in accordance with at least some embodiments. In some cases, the size of the solar panel may be too wide (e.g., greater than about 0.6 m) to benefit from mounting tabs alone, and thus a mounting strap is contemplated. In particular, FIG. 6A shows two example mounting straps 602 and 604 coupled to the outer surface of the back cover (i.e., back cover 108 of FIG. 1). In example systems, the mounting straps may be made of metallic material (e.g., steel, titanium, or aluminum), or alternatively composite plastic.

While two example mounting straps are shown, any number of mounting straps may be contemplated in order to enable sufficient support and stress reduction regarding the layers of the solar panel 100. Furthermore, while the example mounting straps are illustrated as residing parallel to one another, as well as parallel to the “short” side of the solar panel 100, in other cases mounting straps may reside in a configuration parallel to the “long” side of the solar panel 100. The distance 624 ‘D’ between the two mounting straps 602 and 604 is dependent upon the strength of the solar panel 100 itself (e.g., type and thickness of cover layer glass, and type and thickness of the back cover glass), but in some cases is the distance is about 0.6 m.

So as not to unduly complicate the discussion, example mounting strap 602 will be discussed as representative of both mounting straps. In particular, example mounting strap 602 defines distal portion or mounting flange 606 at one end, a second distal portion or mounting flange 610 opposite mounting flange 606, and a medial strap member 612 disposed between the two mounting flanges. Mounting flange 606 is that portion of the mounting strap 602 that extends beyond the outer perimeter 118. Mounting flange 610 is that portion of the mounting strap 602 that extends beyond the outer perimeter 118 on the opposite side of the solar module. The example mounting strap 602 also defines notches similar to the notches discussed with respect the mounting tabs, with the notches disposed at the intersection of the outer perimeter 118 and the mounting strap 602. In other cases, hinges may be used in the mounting straps, combinations of notches, grooves, and hinges may be used, or no features at the intersection of the outer perimeter 118 and the mounting strap 602. The example mounting flanges 606 and 610 each define respective apertures 608 and 609, through which mounting hardware may be disposed to enable coupling between the solar panel 100 and a mounting structure. But in other cases the apertures 608 and 609 may be omitted.

The length of the example mounting strap 602 from the distal edge of mounting flange 606 to the distal edge of mounting flange 610 may be length 620 ‘L’, where length 620 ‘L’ is greater than the width 618 ‘W’ of solar panel 100 by about 50 mm (e.g., each mounting flange extends beyond the outer perimeter by about 25 mm). The width 616 ‘W2’ of mounting strap 602 may be about 75 mm, and the thickness (not specifically shown in FIG. 6A) may be about 0.75 mm. Other lengths, widths, and thicknesses may be used. A more detailed explanation of the adhesively coupled mounting straps follows with respect to FIGS. 6B and 6C,

FIG. 6B shows a cross-sectional view (along line 6B-6B of FIG. 6A). In particular, FIG. 6B shows example mounting strap 602 coupled to the outer surface of the back cover (i.e., back cover 108 of FIG. 1) of the solar panel 100 by way of adhesive layer 614. As before, the adhesive layer may be, but is not limited to, a double-sided tape or a silicon adhesive. In the example system of FIG. 6B, the adhesive layer 614 extends along the full width 618 ‘W’ of the solar panel 100, in some cases stopping at or just prior to the outer perimeter 118. In other cases, the adhesive layer need not span the full width, and may be segmented (e.g., have gaps where no adhesive is present) along the width.

FIG. 6C shows a cross-sectional view (taken along line 6C-6C of FIG. 6A). In particular, mounting strap 602 is coupled to the outer surface of the back cover (i.e., back cover 108 of FIG. 1) of the solar panel 100 by way an adhesive layer 614, and mounting strap 604 is coupled to the outer surface of the back cover (i.e., back cover 108 of FIG. 1) by way an adhesive layer 612. As can be seen in FIG. 6B, the adhesive layer 612 does not extend fully along the length of solar panel 100; rather the adhesive layer may be comprised of a plurality of adhesive spots (i.e., dots of adhesive) between the mounting strap 602 and the back over 108. The same configuration is true of mounting strap 604 and adhesive layer 614.

After installation to an underlying frame (not shown in FIG. 6A, but such as mounting rails 206 and 208) each mounting strap, when under load, is placed in tension. Since the mounting strap 602 carries at least a portion of the real or simulated load applied to the solar panel, stress on the solar panel is reduced and thus additional structural support may not be necessary. Thus, solar panels which comprise a glass cover layer may use thinner glass, or less expensive glass (e.g., annealed glass instead of heat treated or tempered glass). Likewise, solar modules which use a glass back cover may use thinner glass, or less expensive glass (e.g., annealed glass instead of heat treated or tempered glass). Here as in the mounting tabs versions, the outer perimeter 118 of the solar panel is largely exposed, enabling connector assembly 110 to be conveniently and strategically located on the outer perimeter 118.

The following is a non-limiting list of solar panel sizes that may be used with the example mounting straps, including example distances 624 ‘D’ between the mounting straps: the solar panel has a width of about 1.1 meter (m), a length of about 1.3 m, and the first and second straps disposed along the width and separated by at least 0.2 m; the solar panel has a width of about 1.1 m, a length of about 1.6 m, and the first and second straps disposed along the width and separated by at least 0.2 m; the solar panel has a width of about 1.1 m, a length of about 2.6 m, and the first and second strap disposed along the width and separated by at least 0.2 m. In addition, a third strap may be disposed along the width of the solar panel and separated by at least 0.2 m from the second strap. Further still, a fourth strap may be added and separated by at least 0.2 m from the third strap.

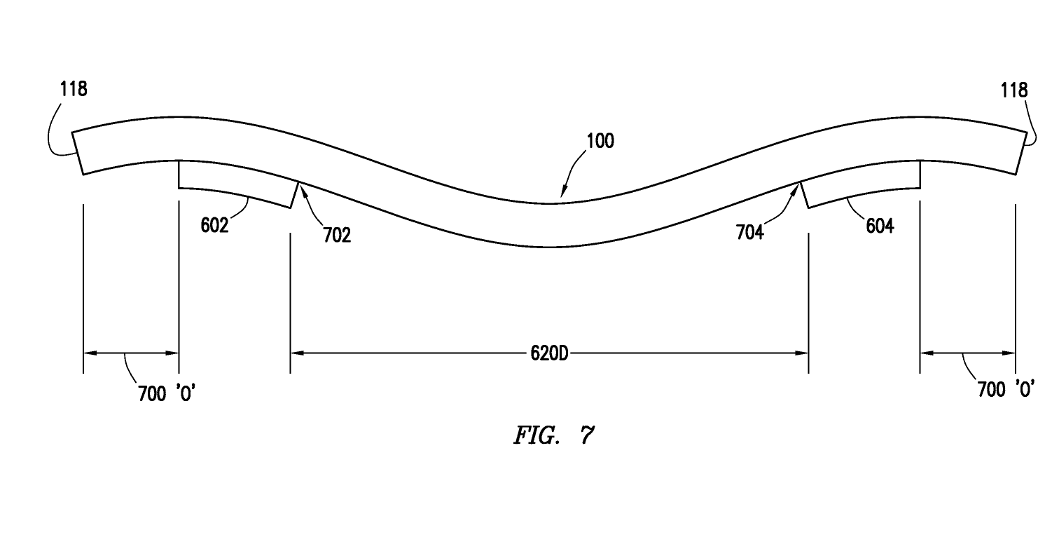

FIG. 7 shows side elevation view of a solar panel 100 mounted using mounting straps, the solar panel deflecting under load (with the deflection exaggerated for clarity). That is, the view of FIG. 7 may be similar to the view of FIG. 6C, but with but with the solar panel turned upward and with exaggerated deflection. In FIG. 7, mounting straps 602 and 604 are coupled to the outer surface of the back cover (i.e., back cover 108 of FIG. 1) of solar panel 100. Visible in FIG. 7 is the distance 624 ‘D’, as well as an additional length consideration, overhang 700 ‘O’. In the figure, the distance 624 ‘D’ is shown to be measured from the internal dimension of the mounting straps, but other equivalent measures are contemplated (e.g., outside dimensions (corrected for width of the mounting straps), center-to-center spacing (corrected for width of the mounting straps)). Likewise, the overhang 700 ‘O’ is shown to be measured on each side from the outside dimension of the mounting straps to the respective portions of the outer perimeter 118, but other equivalent measures are contemplated (e.g., inside dimension of the mounting straps (corrected for width of the mounting straps), center of the mounting straps (corrected for width of the mounting straps)). The overhang 700 ‘O’ may be considered a “cantilevered edge.” Example ranges for the overhang 700 ‘O’ and spacing distance 624 ‘D’ are discussed below in the section titled Spacing of Mounting Elements.

Nevertheless, FIG. 7 shows that as the solar panel 100 deflects under real or simulated loads, the example mounting straps 602 and 604 may likewise bend and flex. The bending of flexing of the mounting straps thus reduces the bending or flexing of the various layers of the solar panel at the locations of the mounting straps. Thus, referring momentarily to FIG. 2, rather than stress points caused by rigidly holding the solar panel during deflection under load, the stress in the solar panel is reduced, such as at the locations indicated by arrows 702 and 704. The specification now turns to a discussion of mounting rails.

Mounting Rails

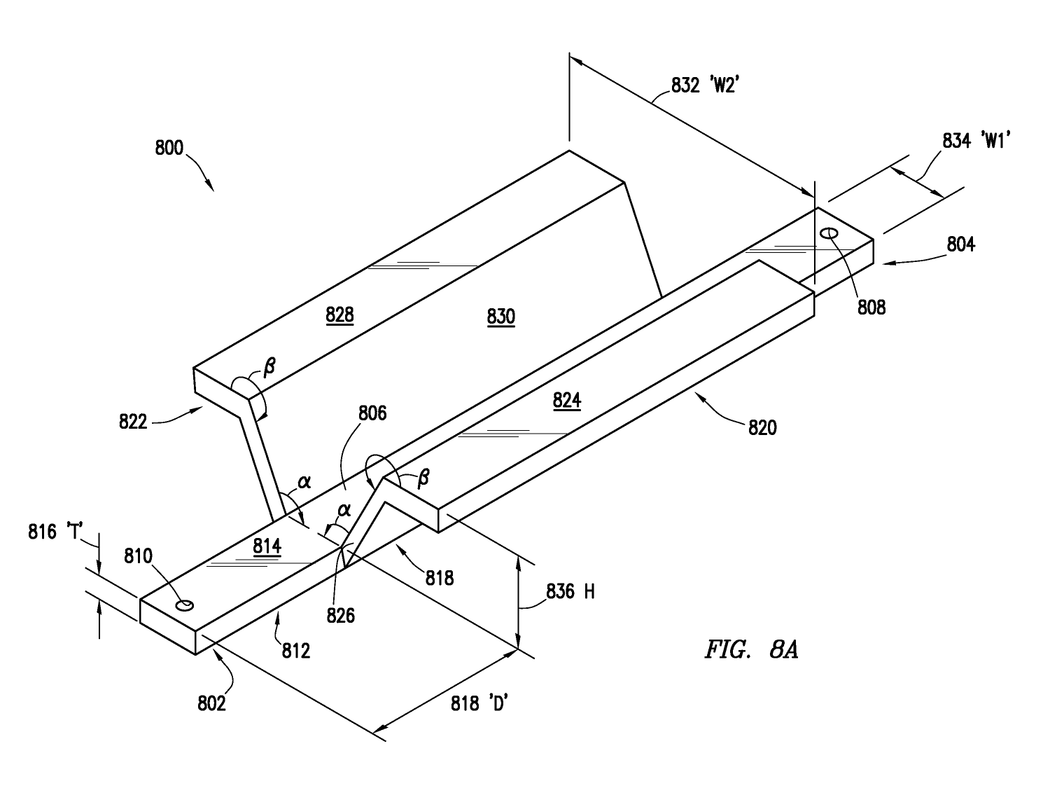

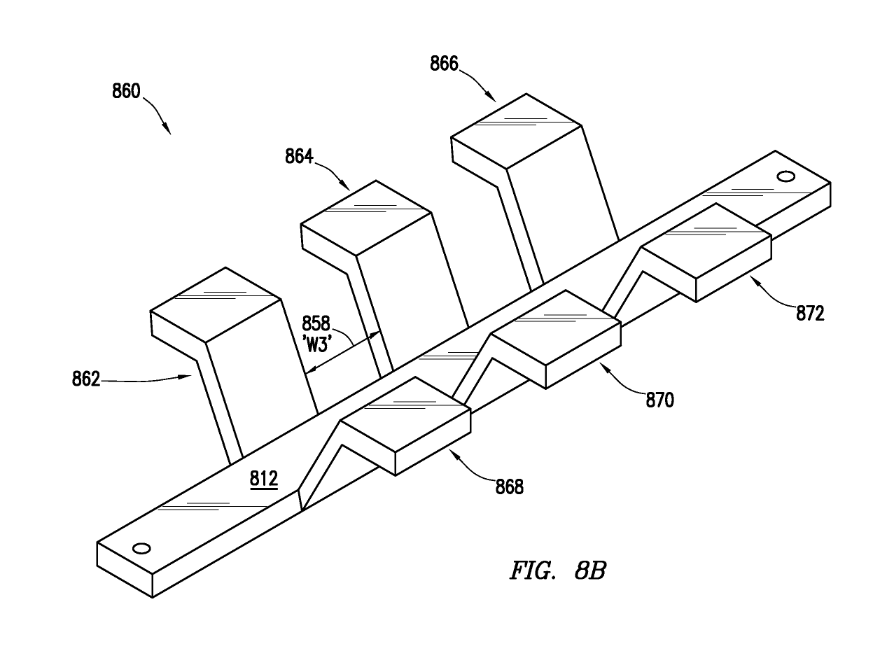

FIG. 8A shows a perspective view of a mounting rail in accordance with at least some embodiments. In some cases, particularly for larger solar panels (e.g., 2.2 m by 2.6 m), the solar panel may be better supported by a mounting rail as opposed to either the mounting tabs or the mounting straps. Moreover, and as discussed more below, use of a mounting rail enables greater spacing between the mounting flange and the outside surface of the back cover 108 (FIG. 1) of the solar panel, which may be useful in some circumstances.

In particular, FIG. 8A shows a perspective view of example mounting rail 800. In one embodiment, mounting rail 800 may be made of metallic material (e.g., steel, titanium, or aluminum), or alternatively composite plastic. Mounting rail 800 is defined by a mounting flange 802 disposed at one end, and a mounting flange 804 disposed opposite mounting flange 802. Each mounting flange has a surface (e.g., the visible upper surface) that defines a flange plane. In some cases the flange planes as between the mounting flanges are coplanar, and when mounted the flange planes are parallel to a back cover plane defined by the back cover 108 (FIG. 1). The example mounting rail 800 further includes medial rail portion 806 disposed between the two mounting flanges 802 and 804. As discussed with respect to previous mounting means, mounting flanges 802 and 804 may optionally include apertures 808 and 810 through which mounting hardware may be disposed to enable coupling of the solar panel to a supporting structure. The portion of the mounting rail between the distal ends of mounting tabs 802 and 804, and including medial rail portion 806, shall be considered the support member 812 for purposes of discussion.

In the example system, the support member 812 defines a three-dimensional rectangular quadrilateral shape, which defines a top surface 814, a bottom surface (not shown in FIG. 8A), and a thickness 816 ‘T’ (which may be approximately 0.75 mm). At a setback based distance 818 ‘D’ from the distal end of mounting tab 802, two wing members 820 and 822 extend from the support member 812. In one embodiment, distance 818 ‘D’ may be 12.5 mm to 25 mm, but the distance may change based on the size of the solar panel to which the mounting rail 800 attaches. The setback distance of the wing members 820 and 822 may be the same with respect to the distal end of flange member 804. Wing members 820 and 822 extend outwardly away from the support member 812 and form an approximately V-shaped cross-section.

Wing member 820 is an approximately L-shaped component that defines a mounting surface 824 coupled on a distal end of a wall member 826 that extends between the support member 812 and the mounting surface 824. The plane defined by the mounting surface 824 may be parallel to a plane defined by visible surface of the support member 812, and the plane defined by the mounting surface 824 defines an angle ‘β’ with respect to a plane defined by the interior wall of the wall member 826, where β may be between and including 190 and 260 degrees. Similarly, the plane defined by the interior wall of wall member 826 defines an angle ‘α’ with the plane defined by support member 812, where a may be between and including 100 and 170 degrees.

Wing member 822 is a mirror image of wing member 820, and thus likewise wing member 822 is an approximately L-shaped component that defines a mounting surface 828 coupled on a distal end of a wall member 830 that extends between the support member 812 and the mounting surface 828. The plane defined by the mounting surface 828 defines an angle ‘β’ with respect to plane defined by the interior wall of the wall member 830, where again β may be between and including 190 and 260 degrees. Similarly, plane defined by the interior wall of wall member 830 defines an angle ‘α’ with the plane defined by support member 812, where a again may be between and including 100 and 170 degrees.

The width 832 ‘W2’ measured between the outside portions of the wing members 820 and 822 is at least three times as great as the width 834 ‘W1’ of the support member 812. The height 836 ‘H’ from the upper surface of the support member 812 to the mounting surfaces 824 and 828 may be about two centimeters (cm). The wall members 826 and 830 each define and reside within a wall plane. If the wall plane from each wall member 826 and 830 were extended below the plane defined by the support member 812, the planes would converge at an offset distances greater than the height 836 ‘H’.

While FIG. 8A shows two wing members 820 and 822 coupled to the support member 812, in another embodiment, the flexible supports may be segmented, as shown with reference to FIG. 8B.

Mounting Rail with Segmented Support Sections

FIG. 8B shows a perspective view of a mounting rail 860 with segmented support sections in accordance with at least some embodiments. Much of the discussion regarding mounting rail 800 applies to mounting rail 860; however, instead of two wing members, mounting rail 860 has six wing members. It should be understood that although six wing members are shown, the number of wing members is not limited to two (in the case of mounting rail 800) or six (in the case of mounting rail 860). The mounting rail 806 of FIG. 8B may be conceptually thought as the mounting rail 800 with multiple wing members on each side. For example, on one side of the support member 812 may reside wing members 862, 864, and 866. Likewise, on the opposite side of support member 812 may reside wing members 868, 870, and 872. The discussion of the wing members with respect to FIG. 8A is equally applicable to each wing member of FIG. 8B, and thus will not be repeated so as not to unduly complicate the disclosure.

In FIG. 8B, however, the wing members are separated by example width 858 ‘W3.’ In some embodiments, width 858 ‘W3’ may be the same between each wing member. In other embodiments, the widths may differ between each wing member. The specification now turns to a discussion of coupling mounting rails to a solar module.

Mounting Rail Coupled to Solar Module

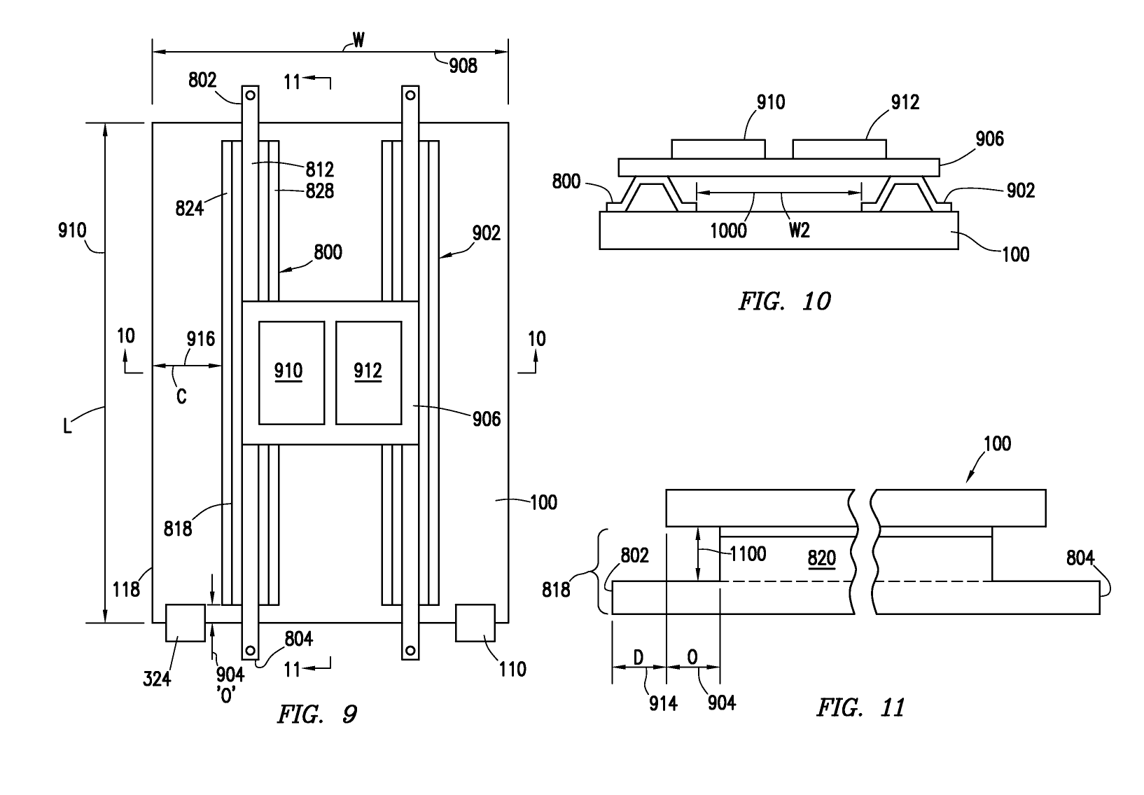

FIG. 9 shows a back elevation view of solar panel 100 having a plurality of mounting rails in accordance with at least some embodiments. While two example mounting rails are shown, any number of mounting rails may be contemplated in order to enable sufficient support and stress reduction regarding the layers of the solar panel 100.

More specifically, mounting rails 800 and 902 are adhesively coupled to solar panel 100. Although not visible in FIG. 9, the mounting surfaces 824 and 828 of wing member 800 are disposed against, and coupled adhesively to, the back cover 108 (FIG. 1) of solar panel 100. The distal ends of the wing members are offset from the outer perimeter of the solar panel by an offset 904 ‘O.’ In one embodiment, offset 904 ‘O’ may be approximately 25 mm. However, in other embodiments, offset 904 ‘O’ may be as much as 0.45 m. In yet still other embodiments, offset 904 ‘O’ may be zero; in other words, the distal ends of the wing members may be flush with the outer perimeter 118 of the solar panel 100. In addition, the mounting rails 800 and 902 may be coupled a distance 916 ‘C’ inwardly from the outer perimeter 118 of the solar panel 100. In one embodiment, distance 916 ‘C’ may be considered a “cantilevered edge.” Considerations regarding the cantilevered edge will be discussed in more detail with respect to FIG. 14.

The mounting flanges 802 and 804 extend outwardly both from the distal ends of the support member, and also extend outwardly from the outer perimeter 118 of solar panel 100. In some embodiments, a mounting plate 906 may be mounted to the mounting rails (e.g., outward surface of the support member 812). Furthermore, because the support member 812 is not coupled in a fully flush configuration with the back cover 108 (FIG. 1), there is clearance between the back cover and the mounting rail onto which solar panel will be mounted. Such clearance enables a variety of advantageous situations. For example, the additional clearance enables adding edge protection around the solar module by way of, for example, reaction injection molding. In yet another embodiment, the additional clearance enables easier coupling to the connector assembly 110. The discussion now turns to a more detailed explanation of clearances provided by use of mounting rails.

FIG. 10 shows a side elevation view of solar panel 100 (taken along line 10-10 of FIG. 9). In particular, FIG. 10 shows solar panel 100 beneath two mounting rails 800 and 902. The mounting rails 800 and 902 are in a parallel configuration to one another. Mounting plate 906 may be coupled to the outer surfaces of the support members of the mounting rails 800 and 902. Coupled to the mounting plate may be a plurality of module subsystems 910 and 912. In one embodiment, mounting rails 800 and 902 are coupled to the solar panel at a distance 1000 ‘W2’ from one another. In the example case of FIG. 10, the distance W2 is measured between the inside surfaces of the mounting rails, but other equivalent measures are contemplated (e.g., outside surfaces (corrected for width), center-to-center spacing (corrected for width), or any other suitable measure.

FIG. 11 shows a side elevation view (taken along lines 11-11 of FIG. 9). In particular, FIG. 11 more clearly shows the spacing relationships between the distal end of the mounting flange 802, the outer perimeter of the solar panel 100, and the distal end of the wing member 820. More specifically, mounting flange 802 extends outwardly from the outer perimeter of solar panel 100 by a distance 914 ‘D.’ As previously discussed, in one embodiment, D may be approximately 12.5 mm to 25 mm. In addition, the offset 904 ‘O’ between the distal ends of the example wing member 820 and the outer perimeter of the solar panel 100 may approximately 25 mm; however, in other embodiments, offset 904 ‘O’ may be as much as 0.45 m. Further, FIG. 11 shows the distance 1100 between the a plane defined by the back cover 108 (FIG. 1) and a plane defined by the mounting flange 802. In example cases the distance (measured perpendicularly between the planes) may be at least 2 cm. The specification now turns to a discussion of a mounting sheet.

Mounting Sheet

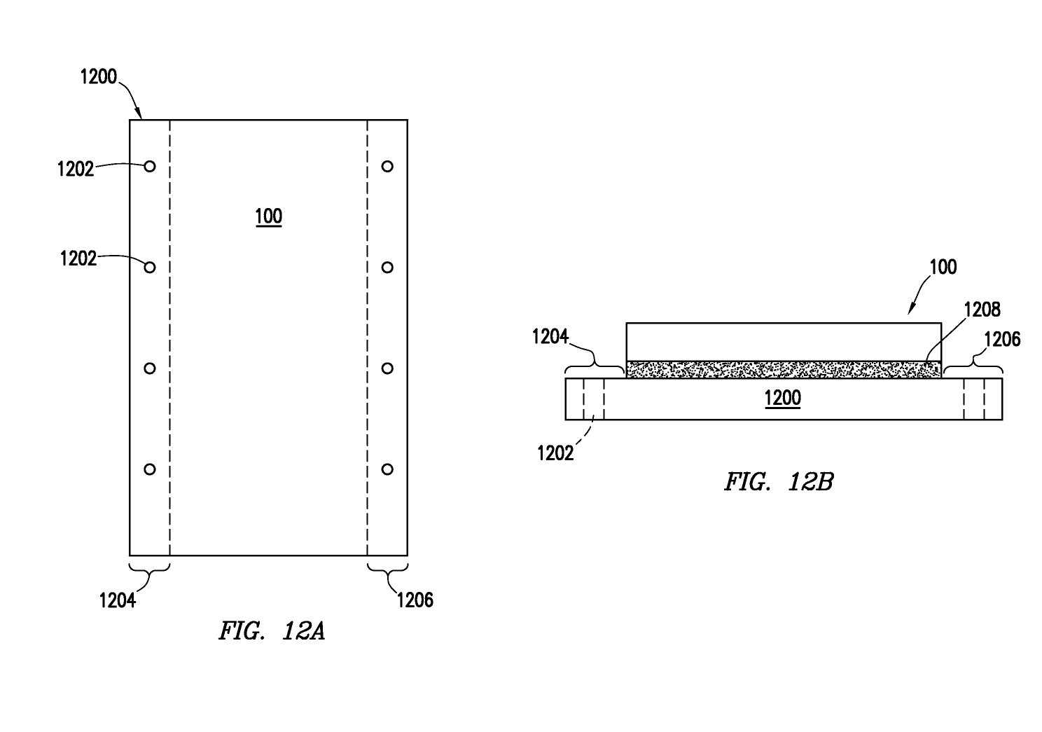

FIG. 12A shows a back elevation view of solar panel 100 having a mounting sheet. In particular, mounting sheet 1200 is a continuous sheet of metallic material (e.g., steel, aluminum), or alternatively composite plastic. The mounting sheet 1200 is coupled to the back cover 108 (FIG. 1) of solar panel 100. Mounting sheet 1200 may align in a flush configuration along the one set of sides of the solar panel 100; however, the mounting sheet 1200 extends outwardly beyond the outer perimeter of the solar panel 100 on the other sides. The outwardly extending portions of the mounting sheet 1200 are considered mounting flanges 1204 and 1206.

In addition, mounting sheet 1200 comprises a plurality of apertures 1202 through which mounting hardware may be disposed to enable coupling between the solar panel 100 and a mounting structure (e.g., mounting rail 206). The plurality of apertures may be disposed along the mounting flanges 1204 of the mounting sheet. Mounting flange 1206 may have a similar set of apertures (not specifically numbered).

In one embodiment, the mounting sheet 1200 supports the entire back side of the layers of the solar panel 100 and thus carries the entire load of the solar panel. As discussed previously with regard to the mounting tabs, the mounting straps, and the mounting rail, the mounting sheet is in tension when loads are applied to the surface of the solar panel. Since the mounting sheet 1200 carries the entire load, the solar panel may not have to provide any additional structural support. Thus, solar panels which comprise a glass cover layer may use thinner glass, or less expensive glass (e.g., annealed glass instead of heat treated or tempered glass). In another embodiment, a clear plastic may be used in the place of glass.

FIG. 12B shows a side elevation view of solar panel of FIG. 12A. In particular, FIG. 12B shows mounting sheet 1200 disposed beneath and coupled to the back cover 108 (FIG. 1) by way of an adhesive layer 1208. As can be seen in FIG. 12B, the flange portions 1204 and 1206 of the mounting sheet 1200 extend outwardly from the outer perimeter of solar panel 100. The specification now turns to a discussion of alternative mounting embodiments.

Alternative Mounting

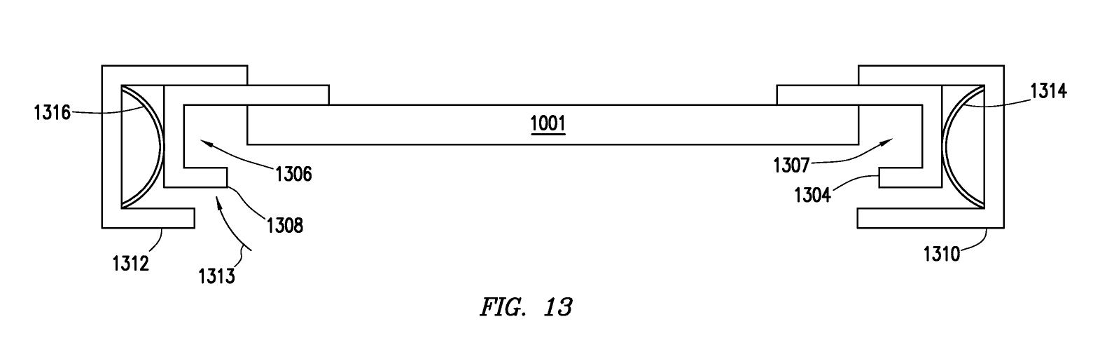

FIG. 13 shows a cross-sectional side elevation view of an alternative mounting system in accordance with at least some embodiments. Although a variety of mounting methods have been previously discussed, particular with regard to mounting hardware disposed through apertures in the various mounting means, an alternative mounting system is contemplated. In particular, the support structure into which the solar panel 100 will be mounted may be comprised of c-shaped mounting structures 1310 and 1312.

In one embodiment, the solar panel 100 may couple to mounting flanges 1302 and 1306, shown in FIG. 13 as mounting tabs, but which may be implemented by any of the previously discussed embodiments. In one embodiment, such as shown in FIG. 13, the distal ends mounting flanges 1302 and 1306 may comprise c-shaped portions 1304 and 1316, respectively. In another embodiment, however, the alternative mounting system is enabled without the c-shaped portions 1304 and 1316. In other words, the mounting flanges may be in the rectangular configurations previously discussed.

C-shaped mounting structure 1310 will be discussed in more detail, with the understanding that the discussion applies to c-shaped mounting structure 1312 as well. In particular, a spring 1314 is coupled to the inner portion of mounting structure 1310. The spring 1314 may be any object which stores mechanical energy, and may be made out of any suitable material, such as metal or plastic.

When mounting the solar panel 100 within the c-shaped mounting structures, the distal end of the mounting tab (i.e., c-shaped portion 1304) is telescoped within the inner portion of mounting structure 1310. Pressure is placed on the spring 1314 by the c-shaped portion 1304, thus compressing the spring. With the spring 1314 compressed, the distal end of the opposite mounting tab (i.e., c-shaped portion 1308) is placed in the mounting structure 1312 as illustrated by arrow 1313 (i.e., by rotation about the mounting flange 1302). When the solar panel 100 is released, the spring 1314 decompresses slightly and pushes the mounting flange 1306 against spring 1316, which compresses spring 1316 slightly. The springs thus hold the solar panel 100 within the structures 1310 and 1312 in a mounted position.

Spacing of Mounting Elements

Thus far, a number of mounting systems, including example dimensions and spacing, have been discussed (e.g., tabs, straps, rails, a sheet). The number of mounting elements, and the spacing between each element, however, are subject to wide variation. For example, for solar panel designs with thicker glass (or stronger glass), the relationships regarding spacing between elements and lengths of cantilevered edges will in most cases get larger. Likewise, for solar panel designs with thinner glass (or weaker glass, or non-use of glass), the relationships regarding spacing between elements and lengths of cantilevered edges will in most cases get smaller.

FIG. 14 shows, in graphical form, an example set of calculated distances between mounting systems in accordance with at least some embodiments, as well as related set of cantilevered edge lengths. The example distances and overhang lengths of FIG. 14 are based on a particular set of assumptions regarding the total thickness of glass of the solar module (cover layer glass thickness and type, back cover glass thickness and type). For example, the allowable stress level for annealed glass may be 13.1 megapascals (MPa), and the IEC mechanical load test may require a load level of 2400 Pa. In particular, line 1406 depicts the relationship of possible spacing 1404 between mounting elements of a solar module based on the overall solar panel thickness 1402. Line 1408 depicts the relationship of possible cantilevered overhang length 1404 based on the same overall solar panel thickness 1402.

Consider the following example: if the overall thickness of the various layers of a solar panel is 3.8 mm, the example mounting straps may be spaced about 0.4 m apart from one another. For the example thickness of 3.8 mm, the length of the cantilevered edge (e.g., distance 700 ‘O’ of FIG. 7, and distance 900 ‘O’ of FIG. 9) will need to be about 0.18 m. Thus, for the particular set of assumptions regarding the layers of the solar panel, and assuming two mounting straps as the mounting means, the length of the solar panel; (e.g., length 622 ‘L2’ of FIG. 6A) would be about 0.8 m (taking into account width of the mounting straps).

One having ordinary skill, now understanding the various types of mounting structures and relationships based on this specification, could determine similar relationships for any particular situation.

References to “one embodiment,” “an embodiment,” “some embodiment,” “various embodiments,” or the like indicate that a particular element or characteristic is included in at least one embodiment of the invention. Although the phrases may appear in various places, the phrases do not necessarily refer to the same embodiment.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A solar module, comprising:
a cover layer;
a solar array that defines a first side and a second side, the first side of the solar array coupled to the cover layer;
a back cover that defines an inside surface and an outside surface opposite the inside surface, the inside surface coupled to the second side of the solar array;
the cover layer, solar array, and back cover together define an outer perimeter, and the outside surface of the back cover defines a back cover plane;
a first mounting flange coupled to the outside surface of the back cover within the outer perimeter, and the first mounting flange extends outward beyond the outer perimeter; and
a second mounting flange coupled to the outside surface of the back cover within the outer perimeter, and the second mounting flange extends outward beyond the perimeter in a direction opposite the first mounting flange.

2. The solar module of claim 1 further comprising:
a cover plane defined by an outside surface of the cover layer, the cover plane parallel to the back cover plane;
a side surface defined at the outer perimeter, the side surface residing between the cover plane and the back cover plane; and
a connector assembly disposed on the side surface; and
a first electrical lead disposed within the connector assembly

3. The solar module of claim 2 further comprising a second electrical lead disposed within the connector assembly, the first and second electrical leads electrically coupled to the solar array.

4. The solar module of claim 2 further comprising:
the outer perimeter defines a quadrilateral with a first side parallel to a second side;
the first mounting flange extends outward beyond the outer perimeter on the first side; and
the connector assembly disposed on the side surface defined by the first side.

5. The solar module of claim 2 further comprising:
the outer perimeter defines a quadrilateral with a first side perpendicular to a second side;
the first mounting flange extends outward beyond the outer perimeter on the first side; and
the connector assembly disposed on the side surface defined by the second side.

6. The solar module of claim 1 further comprising:
a first strap member that defines the first mounting flange, the second mounting flange, and a medial portion disposed between the first and second mounting flanges; and
the medial portion of the first strap adhered to the outside surface of the back cover.

7. The solar module of claim 6 further comprising:
the outer perimeter defines a quadrilateral with a first side parallel to a second side, the first side defines a length measured along the first side; and
the first strap member has a length measured parallel to the first side, the length of the strap member at least 70% as long as the length of the first side.

8. The solar module of claim 7 wherein the length of the first strap member is at least one selected from the group consisting of: at least 80% as long as the length of the first side; at least 90% as long as the length of the first side; equal the length of the first side.

9. The solar module of claim 7 wherein the cover layer is annealed glass.

10. The solar module of claim 6 further comprising:
a second strap member that defines the third mounting flange, a fourth mounting flange opposite the third mounting flange, and a medial portion disposed between the third and fourth mounting flanges;
the medial portion of the second strap member adhered to the back side of the back cover;
the third mounting flange extends outward beyond the outer perimeter in the same direction as the first mounting flange; and
the fourth mounting flange extends outward beyond the outer perimeter in the same direction as the second mounting flange.

11. The solar module of claim 10 further comprising:
a first edge defined along the outer perimeter, the first edge defines a straight section of the outer perimeter;
the first strap member and second strap member are parallel to each other; and
the first strap member and second strap member are parallel to the first edge.

12. The solar module of claim 10 further comprising:
the cover layer is annealed glass; and
the solar module having at least one configuration selected from the group consisting of: the solar module has a width of about 1.1 meter (m), a length of about 1.3 m, and the first and second strap disposed along the width and separated by at least 0.2 m; the solar module has a width of about 1.1 m, a length of about 1.6 m, and the first and second strap disposed along the width and separated by at least 0.2 m; the solar module has a width of about 1.1 m, a length of about 2.6 m, and the first and second strap disposed along the width and separated by at least 0.2 m.

13. The solar module of claim 6 wherein the first strap member is constructed of at least one material selected from the group consisting of: metal; steel; aluminum; and
composite plastic.

14. The solar module of claim 6 further comprising:
a first notch in the first mounting flange, the first notch defines a channel perpendicular to the back cover plane, and first notch disposed at an intersection of the first flange and the outer perimeter; and
a second notch in the first mounting flange, the second notch disposed on an opposite side of the first mounting flange from the first notch, the second notch disposed at an intersection of the first flange and the outer perimeter.

15. The solar module of claim 6 further comprising a first hinge defined on a first surface of the first mounting flange, the first hinge parallel to the outer perimeter, and the first hinge disposed at the intersection of the first flange and the outer perimeter.

16. The solar module of claim 1 further comprising:
the outer perimeter defines a polygon that defines a first side parallel to a second side;
the first mounting flange defines a distal portion that extends beyond the outer perimeter on the first side, and a proximal portion adhered to the outer surface of the back cover, the proximal portion defines a length measured perpendicular to the first side, and the length less than a distance between the first side and the second side;
the second mounting flange defines a distal portion that extends beyond the outer perimeter on the second side, and a proximal portion adhered to the outer surface of the back cover, the proximal portion of the second mounting flange defines a length measured perpendicular to the second side, and the length of the proximal portion of the second mounting flange less than the distance between the first side and the second side.

17. The solar module of claim 16 further comprising:
a third mounting flange coupled to the outside surface of the back cover, the third mounting flange extends outward beyond the outer perimeter in the same direction as the first mounting flange;
a fourth mounting flange coupled to the outside surface of the back cover, the fourth mounting flange extends outward beyond the outer perimeter in the same direction as the second mounting flange;
the third mounting flange defines a distal portion that extends beyond the outer perimeter on the first side, and a proximal portion adhered to the outer surface of the back cover, the proximal portion of the third mounting flange defines a length measured perpendicular to the first side, and the length of the proximal portion of the third mounting flange less than the distance between the first side and the second side; and
the fourth mounting flange defines a distal portion that extends beyond the outer perimeter on the second side, and a proximal portion adhered to the outer surface of the back cover, the proximal portion of the fourth flange defines a length measured perpendicular to the second side, and the length of the proximal portion of the fourth mounting flange less than the distance between the first side and the second side.

18. The solar module of claim 17 further comprising:
the cover layer is annealed glass; and
the solar module has a width of about 0.6 meter (m), a length of about 1.1 m, and the first and third mounting flange separated by at least 0.2 m.

19. The solar module of claim 16 wherein the first mounting flange and the second mounting flange are constructed of at least one material selected from the group consisting of: metal; steel; aluminum; and composite plastic.

20. The solar module of claim 16 further comprising:
a first notch in the first mounting flange, the first notch defines a channel perpendicular to the back cover plane, and the first notch disposed at an intersection of the first flange and the outer perimeter; and
a second notch in the first mounting flange, the second notch disposed on an opposite side of the first mounting flange from the first notch, the second notch disposed at an intersection of the first flange and the outer perimeter.

21. The solar module of claim 16 further comprising a first hinge defined on a first surface of the first mounting flange, the first hinge parallel to the outer perimeter, and the first hinge disposed at the intersection of the first flange and the outer perimeter.

22. The solar module of claim 1 further comprising:
a surface of the first mounting flange defines a first flange plane, the first flange plane parallel to the back cover plane;
the first mounting flange offset away from the back cover by an offset distance measured perpendicularly between the back cover plane and the first flange plane, the offset distance at least 2 centimeters;
a surface of the second mounting flange defines a second flange plane co-planer with the first flange plane;
the second mounting flange offset away from the back cover by an offset distance measured perpendicularly between the back cover plane and the second flange plane, the offset distance of the second mounting flange at least 2 centimeters.

23. The solar module of claim 22 further comprising:
a first support member that defines the first mounting flange, the second mounting flange, and a medial portion disposed between the first and second mounting flanges;
a first mounting surface defined by the medial portion, the first mounting surface adhered to the outside surface of the back cover;
a second mounting surface defined by the medial portion, the second mounting surface distinct from the first mounting surface, the second mounting surface parallel to the first mounting surface, and the second mounting surface adhered to the outside surface of the back cover;
a first wall member coupled to the first mounting surface, the first wall member extends away from the back cover plane in the direction of the first and second flange planes; and
a second wall member coupled to the second mounting surface, the second wall member extends away from the back cover plane in the direction of the first and second flange planes.

24. The solar module of claim 23 further comprising:
a bottom wall member coupled to a distal end of the first wall member, and coupled to a distal end of the second wall member, the bottom wall defines a support plane parallel to the back cover plane; and
the first mounting flange an extension of the bottom wall; and
the second mounting flange an extension of the bottom wall.

25. The solar module of claim 23 further comprising:
a first wall plane defined by the first wall member;
a second wall plane defined by the first wall member; and
wherein the first wall plane and the second wall plane converge at an offset distance from the back cover plane greater than the offset distance defined by the first flange plane.

26. The solar module of claim 23 further comprising:
the cover layer is annealed glass;
a third mounting flange coupled to the outside surface of the back cover, the third mounting flange extends outward beyond the outer perimeter in the same direction as the first mounting flange;
a fourth mounting flange coupled to the outside surface of the back cover, the fourth mounting flange extends outward beyond the outer perimeter in the same direction as the second mounting flange;
a surface of the second mounting flange defines a third plane, the third flange plane parallel to the back cover plane;
the third mounting flange offset away from the back cover by an offset distance measured perpendicularly between the back cover plane and the third flange plane, the offset distance at least 2 centimeters;
a surface of the fourth mounting flange defines a fourth flange plane co-planer with the third flange plane;
the second mounting flange offset away from the back cover by an offset distance measured perpendicularly between the back cover plane and the second flange plane, the offset distance of the second mounting flange at least 2 centimeters.
a second support member that defines the third mounting flange, the fourth mounting flange, and a medial portion disposed between the third and fourth mounting flanges;
a third mounting surface defined by the medial portion of the second support member, the third mounting surface distinct from the first and second mounting surface, and the third mounting surface adhered to the outside surface of the back cover;
a fourth mounting surface defined by the medial portion of the second support member, the fourth mounting surface distinct from the first, second, and third mounting surface, the second mounting surface parallel to the first mounting surface, and the fourth mounting surface adhered to the outside surface of the back cover;
a third wall member coupled to the third mounting surface, the third wall member extends away from the back cover plane in the direction of the third and fourth flange planes; and
a fourth wall member coupled to the fourth mounting surface, the fourth wall member extends away from the back cover plane in the direction of the third and fourth flange planes;
the solar module having at least one configuration selected from the group consisting of: the solar module has a width of about 1.1 meter (m), a length of about 1.3 m, and the first and second support members disposed along the width and separated by at least 0.2 m; the solar module has a width of about 1.1 m, a length of about 1.6 m, and the first and second support members disposed along the width and separated by at least 0.2 m; the solar module has a width of about 1.1 m, a length of about 2.6 m, and the first and second support members disposed along the width and separated by at least 0.2 m.
